(19) United States
(12) Patent Application Publication
(10) Pub. No.: US 2006/0174309 A1
(43) Pub. Date: Aug. 3, 2006

(54) System and method of managing set top box memory

(75) Inventor: Larry B. Pearson, San Antonio, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/046,191

(22) Filed: Jan. 28, 2005

(51) Int. Cl. H04N 7/173; H04N 7/16

(52) U.S. Cl. 725/134; 725/142; 725/90; 725/100

(57) ABSTRACT

A method of managing recorded content at a set top box memory device for use by a digital video recorder is provided. The method includes dividing a total memory capacity of the set top memory device into a plurality of memory portions. Further, the method includes assigning a unique user name to each of the plurality of memory portions. In a particular embodiment, the method further includes receiving an indication to record at least one content item associated with a selected user name. The at least one content item is recorded within one of the plurality of memory portions associated with the selected user name. Additionally, a title associated with the at least one content item is placed on a play list assigned to the selected user name.

### FIELD OF THE DISCLOSURE

The present disclosure relates to set top boxes.

### BACKGROUND

For years, televisions have been a staple of consumer electronics sales. As such, a large majority of households in the United States owns at least one television. Providing content to those televisions is a lucrative business and there are numerous types of television content to choose from. For example, viewers can subscribe to digital broadband television networks and digital satellite television networks in order to receive standard digital television content or high definition television content. In addition, many companies now offer digital video recorders (DVRs) that can be incorporated into standard set top boxes. A DVR can be used to record digital television content transmitted to the set top box.

When multiple users program the DVR to record content, certain problems can arise. For example, the total storage can quickly be consumed when many users are programming the DVR. Additionally, a first user may have recorded a particular content item that they do not want erased. However, a second user may have programmed the DVR to record another content item in such a manner that would cause the first user's content item to automatically be erased, e.g., to make room to store the second user's desired content item. Further, when multiple users have access to the DVR it can be difficult to quickly locate recorded content associated with a particular user because all recorded content is stored in a common area.

Accordingly, there is a need for an improved system and method of managing set top box memory.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of an entertainment system;

FIG. 2 is a general diagram representative of an embodiment of a graphical user interface that can be used to select a user name associated with a set top box;

FIG. 3 is a general diagram representative of an embodiment of a graphical user interface that can be used to input a personal identification associated with a user name;

FIG. 4 is a general diagram representative of an embodiment of a graphical user interface that can be used to access content associated with a user name;

FIG. 5 is a general diagram representative of an embodiment of a graphical user interface that can be used to present a record list associated with a user name;

FIG. 6 is a general diagram representative of an embodiment of a graphical user interface that can be used to present a play list associated with a user name;

FIG. 7 is a flow chart to illustrate a method of managing memory at a set top box;

FIG. 8 is a flow chart to illustrate a first portion of a method of managing content stored at a set top box; and

FIG. 9 is a flow chart to illustrate a second portion of a method of managing content stored at a set top box.

### DETAILED DESCRIPTION OF THE DRAWINGS

A method of managing recorded content at a set top box memory device for use by a digital video recorder is provided. The method includes dividing a total memory capacity of the set top memory device into a plurality of memory portions. Further, the method includes assigning a unique user name to each of the plurality of memory portions.

In a particular embodiment, the method further includes receiving an indication to record at least one content item associated with a selected user name. The content item is recorded within one of the plurality of memory portions associated with the selected user name. Additionally, a title associated with the content item is placed on a play list assigned to the selected user name.

In a particular embodiment, the method also includes displaying a plurality of distinct play lists. A different user name can be assigned to each of the plurality of distinct play lists. In a particular embodiment, each of the plurality of memory portions has an equal storage capacity. In another embodiment, each of the plurality of memory portions can have a different storage capacity. Further, in a particular embodiment, a storage capacity of each of the plurality of memory portions can be defined by a user.

In another embodiment, a method of recording content at a set top box is provided. The method includes receiving a content item to be recorded on behalf of a first user. Also, the method includes storing the received content item in a first memory portion of the memory device allocated to the first user. A second memory portion of the memory device is allocated to a second user.

In still another embodiment, a set top box device for managing video content is provided. The set top box device includes a processor and a tuner that is coupled to the processor. Further, a content feed is coupled to the processor. Additionally, the set top box device includes a computer readable medium that is accessible by the processor. A computer program is embedded within the computer readable medium and includes instructions to display a graphical user interface at a display device. In particular, the graphical user interface includes a first play list of video content assigned to a first user name and a second play list of video content assigned to a second user name.

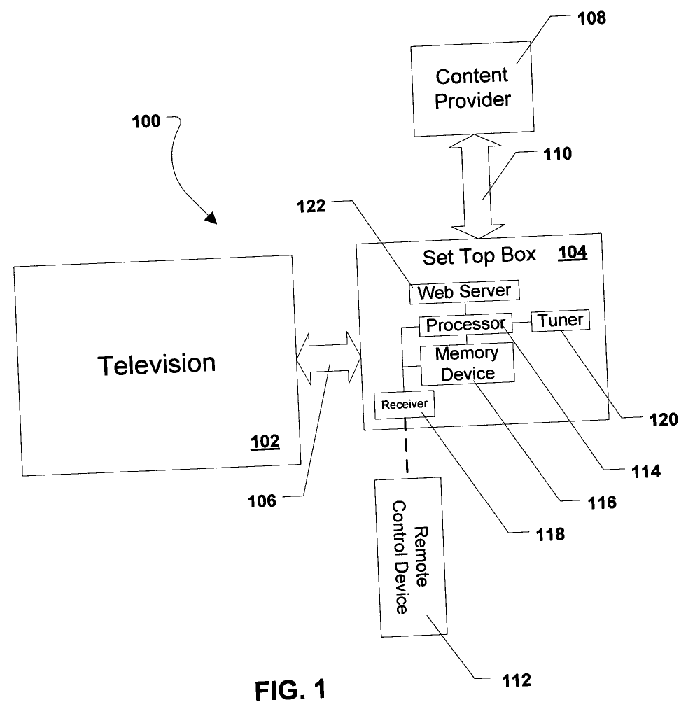

Referring to FIG. 1, a system is illustrated and is generally designated 100. As illustrated in FIG. 1, in an exemplary, non-limiting embodiment, the system 100 includes a television 102, but it can be appreciated that the system 100 can include any display device on which video content can be displayed. FIG. 1 indicates that a set top box 104 can be connected to the television 102 via a first broadband connection 106. The set top box 104 is also connected to a content provider 108, e.g., a cable company or a digital satellite company, via a second broadband connection 110. In particular, the second broadband connection 110 serves as a content feed for the set top box 104. FIG. 1 also depicts a remote control device 112 that can communicate with the set top box 104 to allow user interaction with the system 100 during operation. The remote control device 112 can communicate with the set top box 104 via one or more infrared (IR) signals, radio frequency (RF) signals, or other wireless signals. Additionally, the remote control device 112 can be used to provide one or more user inputs to the set top box 104.

As indicated in FIG. 1, the set top box 104 includes a processor 114 in which logic, such as user interface logic, can be executed. Further, the set top box 104 includes a memory device 116 in which content from the content provider can be downloaded and stored. FIG. 1 also shows that the set top box 104 can include a receiver 118, e.g., an IR/RF receiver, that is configured to receive one or more IR/RF signals from the remote control device 112. A tuner 120 can also be coupled to the processor 114 and to the content feed 110. In a particular embodiment, the memory device 116 is a computer readable medium such as a random access memory (RAM), a flash drive, a hard drive, or any other type of memory device. Further, in another embodiment, the set top box 104 can include multiple memory devices that can be used concurrently to store recorded content. As shown in FIG. 1, the set top box 104 can also include a web server 122 that is embedded therein.

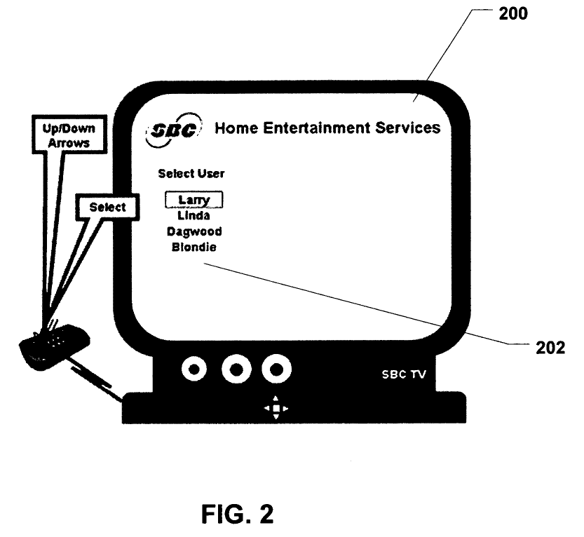

FIG. 2 depicts an exemplary, non-limiting embodiment of a graphical user interface (GUI), generally designated 200, that can be presented to a user at the television 102 (FIG. 1) during operation of the system 100 (FIG. 1). In an alternative embodiment, the GUI 200 can be presented to another device, such as a computer, that is accessing the set top box 104 (FIG. 1) via the web server 122 and the Internet.

As shown in FIG. 2, in one embodiment, the GUI 200 can be a user name selection GUI and can include a user name list 202. In a particular embodiment, the user name list 202 includes a list of users that are authorized to record and view content at the set top box 104 (FIG. 1). Further, in a particular embodiment, each user is allocated a portion of the memory storage provided by the memory device 116 (FIG. 1) and each user can record and view content that is stored in the portion of the memory device that is assigned to that particular user.

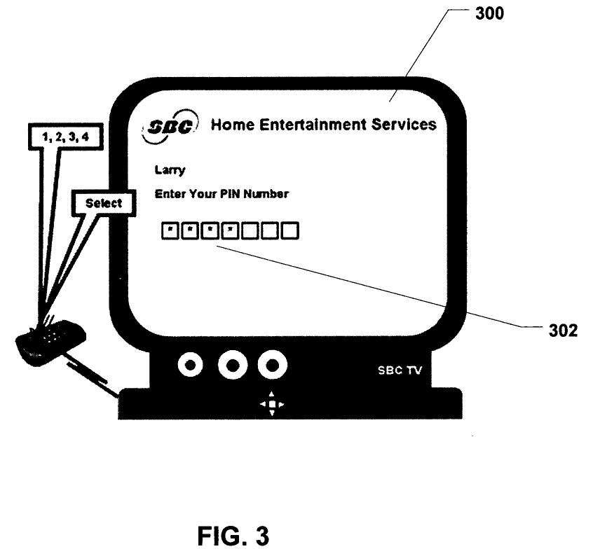

FIG. 3 illustrates another exemplary, non-limiting embodiment of a GUI, generally designated 300, that can be presented to a user at the television 102 (FIG. 1) during operation of the system 100 (FIG. 1). In one embodiment, the GUI 300 is a personal identification number (PIN) entry GUI and can include one or more PIN entry fields 302. In a particular embodiment, after a user name is selected from the user name selection GUI 200 (FIG. 2), the user is presented with the PIN entry GUI 300. In order to access stored content, or program the set top box to record content, the user must correctly input the PIN associated with the selected user name.

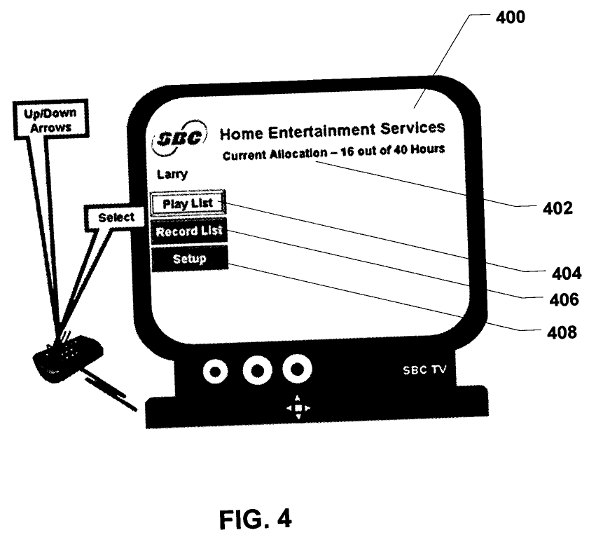

Referring to FIG. 4, still another exemplary, non-limiting embodiment of a GUI is shown and is generally designated 400. In a particular embodiment, the GUI 400 shown in FIG. 4 is a user name home GUI that can be used to access content associated with a selected user name. As depicted in FIG. 4, the user name home GUI 400 can include a current allocation counter 402. In a particular embodiment, the current allocation counter 402 provides an indication of how much content, in hours, has been stored in the memory portion that is allocated to the user and associated with the selected user name. For example, the current allocation counter 402 can indicate X hours used out of Y total hours allocated to the user name, e.g., 16 out of 40 hours. Also, the current allocation counter 402 can provide an indication that the user is using more memory than the minimum memory that is allocated to the user.

FIG. 4 further shows that the user name home GUI 400 includes a play list soft button 404, a record list soft button 406, and a setup soft button 408. In an illustrative embodiment, a user can navigate between the soft buttons 404, 406, 408 using the remote control device.

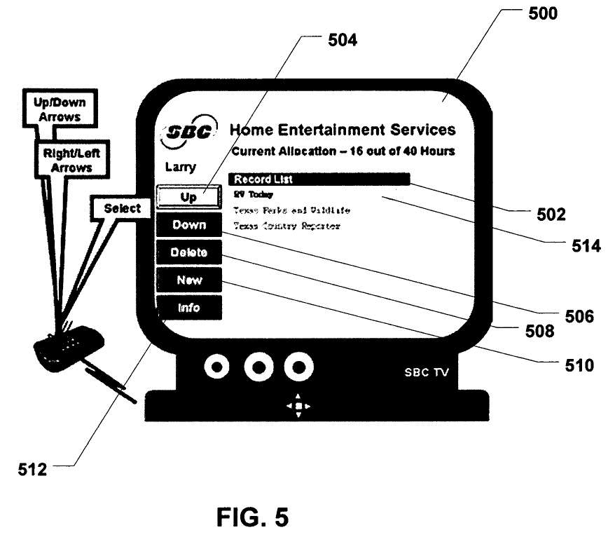

FIG. 5 illustrates an illustrative embodiment of a record list GUI, designated 500, that is presented when the record list soft button 406 (FIG. 4) is selected by the user at the user name home GUI 400 (FIG. 4). As shown, the record list GUI 500 includes a record list 502 that indicates content that has been scheduled to be recorded by the user associated with the user name. Further, the record list GUI 500 includes an up soft button 504, a down soft button 506, a delete soft button 508, a new soft button 510, and an info soft button 512.

In a particular embodiment, the user can navigate between the soft buttons 504, 506, 508, 510, 512 using a remote control device. For example, the remote control device can include an up arrow, a down arrow, a left arrow, and a right arrow. The user can navigate within the column of soft buttons 504, 506, 508, 510, 512 using the up arrow and down arrow at the remote control device. Also, the user can move between the column of soft buttons 504, 506, 508, 510, 512 and the record list 502 using the left arrow and right arrow at the remote control device. Once the user has moved into the record list 502, the user can use the up arrow and down arrow to move a highlight bar 514 along the record list 502.

When the up soft button 504 is selected, the content item that is highlighted by the highlight bar 514 moves up along the record list 502. When the down soft button 506 is selected the content item that is highlighted by the highlight bar 514 moves down along the record list 502. As such, the priority of recording for the content items in the record list 502 can be established by the location of the content items in the record list 502. For example, a content item that is located higher on the record list 502 can overwrite storage that is allocated to a content item that is located lower on the record list 502. Further, if two content items are on at the same time, the content item that is higher on the record list 502 can be recorded and the content item that is lower on the record list 502 cannot be recorded.

When the delete soft button 508 is selected, the item on the record list 502 on which the highlight bar 514 is located is deleted. When the new soft button 510 is selected by a user, a new item can be added to the record list 502. Particularly, when the new soft button 510 is selected, the user can be presented a list of programs, e.g., via a content guide, and a user can select a program that he or she desires the set top box to record.

Further, when the info soft button 512 is selected by a user, information concerning the item on the record list 502 on which the highlight bar 514 is located can be presented to the user. In an exemplary embodiment, the information can include a brief description of the selected item on the record list. Also, the information can include a rating of the content, e.g., TV-Y, TV-Y7, TV-G, TV-PG, TV-14, TV-MA, D, S, L, V, G, PG, R, NR, etc.

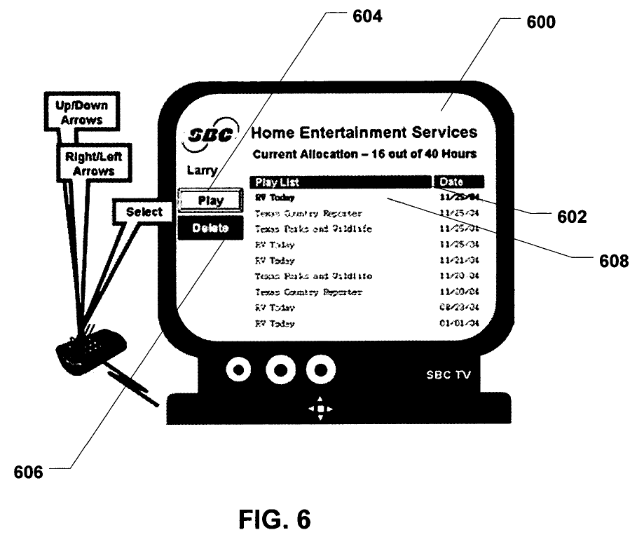

FIG. 6 illustrates an exemplary embodiment of a play list GUI, designated 600, that is presented when the play list soft button 404 (FIG. 4) is selected by the user via the user name home GUI 400 (FIG. 4). As shown, the play list GUI 600 includes a play list 602 that indicates content that is presently recorded at the set top box and that is associated with the selected user name. Additionally, the play list GUI 600 includes a play soft button 604, and a delete soft button 606. A user can select the play soft button 604 or the delete soft button 606 using a remote control device. As further depicted in FIG. 6, the play list GUI 600 can include a highlight bar 608 that a user can move up or down along the play list 602 using the remote control. In an exemplary embodiment, when the play soft button 604 is selected, the content item on which the highlight bar 608 is located can be played from storage at the set top box. Further, when the delete soft button 606 is selected, the content item on which the highlight bar 608 is located can be deleted from the memory device within the set top box.

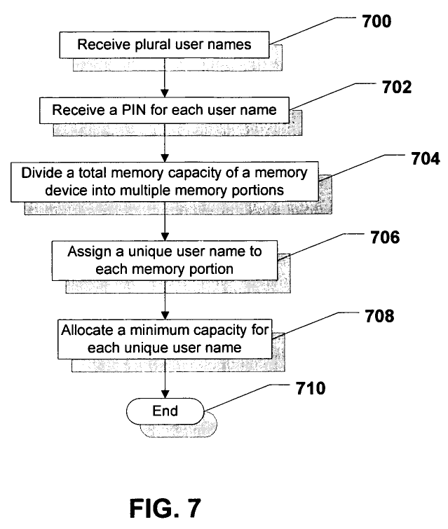

Referring to FIG. 7, a method of managing memory at a set top box is shown and commences at block 700. At block 700, the set top box receives a plurality of unique user names. Next, at block 702, the set top box receives a personal identification number (PIN) for each unique user name. In a particular embodiment, each user name and each PIN can be manually input by a user, e.g., using a remote control device. Moving to block 704, the set top box divides a total memory capacity of a memory device within the set top box into multiple memory portions. In a particular embodiment, the number of memory portions is the same as unique user names input to the set top box. At block 706, the set top box assigns a unique user name to each memory portion. Proceeding to block 708, the set top box allocates a minimum capacity for each unique user name. In a particular embodiment, the minimum capacity for each unique user name is the same. However, the minimum capacity for each user can be different, and an administrative user, e.g., a parent, can set the minimum capacity for each user. For example, the parent can assign himself or herself a larger minimum capacity than a child. The method ends at state 710.

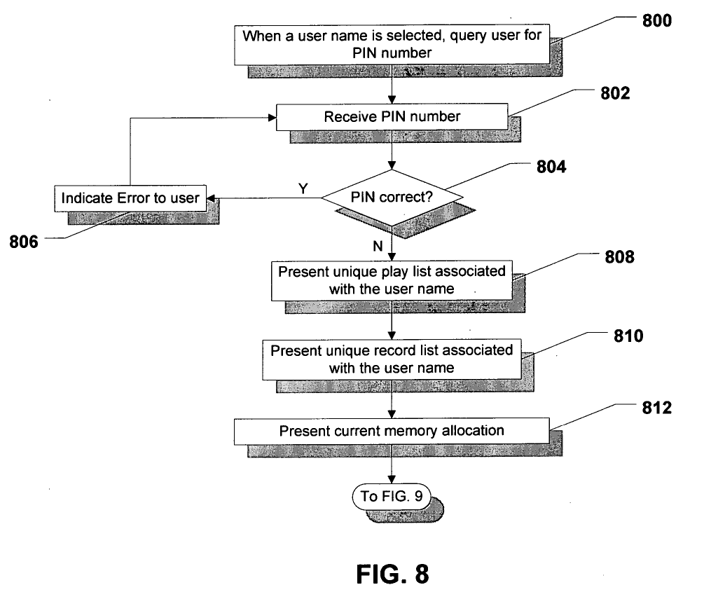

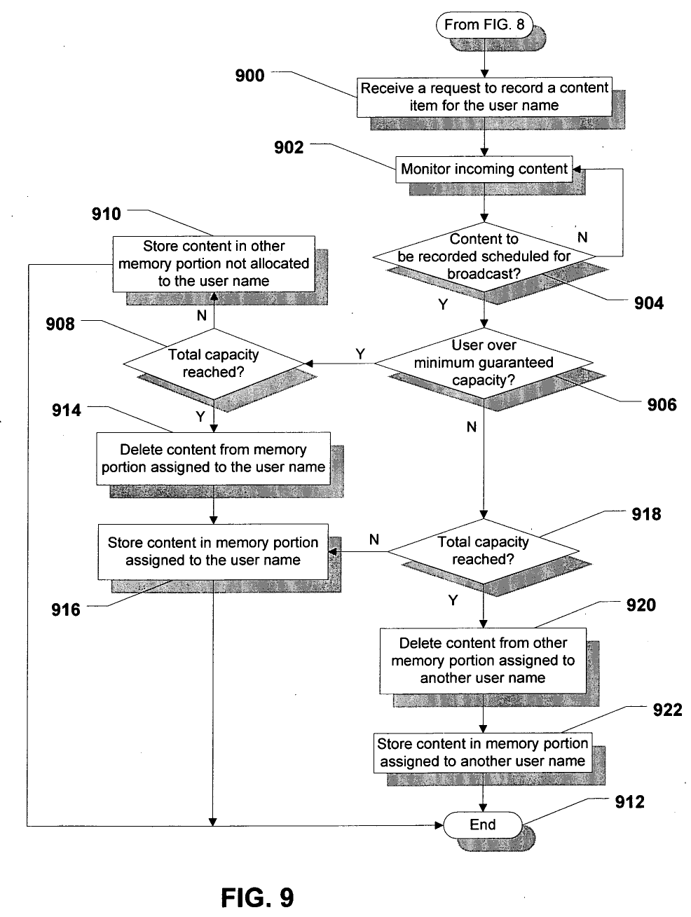

Referring to FIG. 8, a method of managing content at a set top box is shown and commences at block 800. At block 800, when a user selects a user name at the set top box, the set top box queries the user for a personal identification number (PIN) associated with his or her user name. Moving to block 802, the set top box receives the PIN. Thereafter, a decision step 804, the set top box determines whether the PIN is correct. If not, the set top box indicates an error to the user at block 806. The method then returns to block 802 and the set top box receives another PIN from the user. The method then continues as described herein. Returning to decision step 804, if the PIN is correct, the method moves to block 808 and the set top box presents a unique play list associated with the user name. Then, at block 810, the set top box presents a unique record list associated with the user name. Further, at block 812, the set top box presents a current memory allocation for associated with the user name. The method then moves to block 900 of FIG. 9.

At block 900, the set top box receives a request to record a content item for the user associated with the selected user name. Moving to block 902, the set top box monitors the incoming content being sent to the set top box. Thereafter, at decision step 904, the set top box determines whether any content that is to be recorded is scheduled for broadcast. If not, the method returns to block 902 and continues as described herein. If so, the method proceeds to decision step 906 and determines whether the content stored within the memory associated with the user name has exceeded the minimum guaranteed capacity. If so, the method continues to decision step 908 and the set top box determines whether the total storage capacity at the memory device has been reached. If the total storage capacity has not been reached, the method moves to block 910, and the set top box stores the content in another memory portion that is not associated with the user name. In a particular embodiment, the set top box selects a memory portion that has the least amount of content stored therein. The method then ends at state 912.

At decision step 908, if the total capacity has been reached, the set top box deletes the oldest unprotected content from memory portion assigned to the user name at block 914. Next, at block 916, the set top box stores the content in the memory portion assigned to the user name. The method then ends at state 912.

Returning to decision step 906, if the content stored at the memory portion associated with the user name has exceeded the minimum guaranteed capacity for the user, the method proceeds to block 918. At block 918, the set top box determines whether the total storage capacity for the memory device has been reached. If not, the method moves to block 916 and continues as described above. Conversely, if the total storage capacity has been reached, the method proceeds to block 920 and the set top box deletes content from another memory portion assigned to another user name. Thereafter, at block 922, the set top box stores the content in the memory portion assigned to another user name. The method then ends at state 912.

With the configuration of structure described above, the system and method of managing set top box memory provides a way for multiple users to record content into portions of memory that are allocated to each user. Further, a user can easily locate the content that he or she programmed the set top box to record. Additionally, each user can be guaranteed a minimum allocation amount of dedicated memory storage for the user. However, if a user exceeds his or her minimum allocation of dedicated memory storage, a requested program can be stored in another user's dedicated memory storage as long as the total memory for the set top box is not exceeded.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of managing recorded content at a set top box memory device for use by a digital video recorder, the method comprising:
dividing a total memory capacity of the set top memory device into a plurality of memory portions; and
assigning a unique user name to each of the plurality of memory portions.

2. The method of claim 1, further comprising receiving an indication to record at least one content item associated with a selected user name.

3. The method of claim 2, further comprising recording the at least one content item within one of the plurality of memory portions associated with the selected user name.

4. The method of claim 3, further comprising placing a title associated with the at least one content item on a play list assigned to the selected user name.

5. The method of claim 4, further comprising displaying a plurality of distinct play lists.

6. The method of claim 5, wherein a different user name is assigned to each of the plurality of distinct play lists.

7. The method of claim 1, wherein each of the plurality of memory portions has an equal storage capacity.

8. The method of claim 1, wherein each of the plurality of memory portions has a different storage capacity.

9. The method of claim 8, wherein a storage capacity of each of the plurality of memory portions is defined by a user.

10. A method of recording content at a set top box, the method comprising:
receiving a content item to be recorded on behalf of a first user; and
storing the received content item in a first memory portion of the memory device allocated to the first user, wherein a second memory portion of the memory device is allocated to a second user.

11. The method of claim 10, further comprising determining whether a minimum storage space allocated to the first user within a memory device has been exceeded prior to storing the received content item.

12. The method of claim 11, further comprising determining if a total storage capacity of the memory device has been reached prior to storing the received content item.

13. The method of claim 12, further comprising storing the received content item in the second memory portion not allocated to the first user after determining that the minimum storage space allocated to the first user has been exceeded and after determining that the total capacity has not been reached.

14. The method of claim 12, further comprising deleting a stored content item from the first memory portion allocated to the first user after determining that the minimum storage space allocated to the first user has been exceeded and after determining that the total capacity has been reached.

15. The method of claim 14, further comprising storing the received content item in the first memory portion allocated to the first user after determining that the minimum storage space allocated to the first user has not been exceeded and after determining that the total capacity has not been reached.

16. The method of claim 12, further comprising deleting a stored content item from the second memory portion not allocated to the first user after determining that the minimum storage space allocated to the first user has not been exceeded and after determining that the total capacity has not been reached.

17. The method of claim 16, further comprising storing the received content item in the second memory portion not allocated to the first user.

18. A set top box device for managing video content, the device comprising:
a processor;
a tuner coupled to the processor;
a content feed coupled to the processor;
a computer readable medium accessible by the processor; and
a computer program embedded within the computer readable medium, the computer program comprising:
instructions to display a graphical user interface at a display device, the graphical user interface comprising a first play list of video content assigned to a first user name and a second play list of video content assigned to a second user name.

19. The set top box device of claim 18, wherein the first play list is accessible after a correct first personal identification number associated with the first user name is received.

20. The set top box device of claim 19, wherein the first play list includes one or more content items recorded upon request of a first user.

21. The set top box device of claim 19, wherein the second play list is accessible after a correct second personal identification number associated with the second user name is received.

22. The set top box device of claim 21, wherein the second play list includes one or more content items recorded upon request of a second user.

23. The set top box device of claim 18, wherein the graphical user interface further comprises a first record list of video content assigned to the first user name.

24. The set top box device of claim 23, wherein the graphical user interface further comprises a second record list of video content assigned to the second user name.

25. The set top box device of claim 23, wherein the first record list is accessible after the correct first personal identification number associated with the first user name is received.

26. The set top box device of claim 23, wherein the second record list is accessible after the correct second personal identification number associated with the second user name is received.
